(19) United States
(12) Patent Application Publication
(10) Pub. No.: US 2011/0300414 A1
(43) Pub. Date: Dec. 8, 2011

(54) CAP ASSEMBLY AND RECHARGEABLE BATTERY HAVING THE SAME

(76) Inventor: Woonseong Baek, Yongin-si (KR)

(21) Appl. No.: 13/030,104

(22) Filed: Feb. 17, 2011

Related U.S. Application Data
(60) Provisional application No. 61/352,198, filed on Jun. 7, 2010.

(51) Int. Cl. H01M 2/00; H01M 2/30; H01M 2/04

(52) U.S. Cl. 429/7; 429/181

(57) ABSTRACT

A cap assembly, having a reduced number of components and a simplified assembling process, and a secondary battery having the same. A cap assembly includes a cap plate having a first hole, a first electrode terminal inserted into and extending out from the first hole of the cap plate, the first electrode terminal including an upper terminal part, a lower terminal part, and a connection part electrically connecting the upper terminal part with the lower terminal part; and an injection resin molding between the first hole and the first electrode terminal to seal the first hole around the first electrode terminal.

### CROSS-REFERENCE TO RELATED APPLICATION

This application claims priority to and the benefit of U.S. Provisional Application No. 61/352,198, filed on Jun. 7, 2010 in the United States Patent and Trademark Office, the entire content of which is incorporated herein by reference.

### BACKGROUND

1. Technical Field

Aspects of embodiments of present invention relate to a cap assembly and a rechargeable battery having the same.

2. Related Art

Unlike primary batteries, secondary batteries, which can be repeatedly charged and discharged, are widely used for various advanced electronic devices such as cellular phones, notebook computers, camcorders, hybrid electric vehicles (HEV), electric automobiles, electric bicycles, electric scooters, or the like. Lithium ion batteries are particularly attractive because they operate at 3.6 V, a voltage three times higher than that of nickel-cadmium batteries and nickel-hydrogen batteries which are widely used as power supplies for portable electronic appliances. In addition, lithium ion batteries have high energy density per unit weight.

Lithium ion batteries are generally classified into ones using liquid electrolytes or ones using polymer or gel-type electrolytes according to the type of electrolyte used. Lithium ion batteries can also take various shapes, such as prismatic, cylindrical or pouch type shapes.

### SUMMARY

Aspects of embodiments of the present invention are directed toward a cap assembly, which has a reduced number of components and a simplified assembly process, and a secondary battery having the same.

According to one embodiment of the present invention, a cap assembly includes a cap plate having a first hole; a first electrode terminal inserted into and extending out from the first hole of the cap plate, the first terminal including an upper terminal part, a lower terminal part, and a connection part electrically connecting the upper terminal part with the lower terminal part; and an injection resin molding between the first hole and the first electrode terminal to seal the first hole around the first electrode terminal.

According to another embodiment of the present invention, a secondary battery includes a case; an electrode assembly in the case; a protective circuit module electrically coupled to the electrode assembly, and in the case; and a cap assembly electrically coupled to the protective circuit module, and sealing the electrode assembly and the protective circuit module in the case.

In one embodiment of the present invention, an electrode terminal is first coupled to a hole of a cap plate, the cap plate and the electrode terminal are then settled on a mold, and the cap plate and the electrode terminal are subjected to an insertion-molding process using a resin molding, thereby providing a cap assembly with a small or minimal number of components and a simplified assembly process.

In another embodiment of the present invention, a secondary battery having a cap assembly with a small or minimal number of components and a simplified assembly process is provided using an insertion-molding process.

In still another embodiment of the present invention, a compact-sized secondary battery is provided by forming an integrated protective circuit module in a battery cell.

### BRIEF DESCRIPTION OF THE DRAWINGS

FIG. 1 is a perspective view of a secondary battery according to one exemplary embodiment of the present invention;

FIG. 2A is an exploded perspective view of the secondary battery illustrated in FIG. 1, and FIG. 2B is an enlarged view of a portion of FIG. 2A;

FIGS. 3A, 3B and 3C are cross-sectional views taken along lines 3a-3a, 3b-3b and 3c-3c, respectively, of FIG. 2A;

FIG. 4 is a longitudinal cross-sectional view of FIG. 1;

FIGS. 5A and 5B are cross-sectional views illustrating a method of manufacturing a cap assembly according to one exemplary embodiment of the present invention;

FIG. 6 is a cross-sectional view of a cap assembly according to one exemplary embodiment of the present invention;

FIGS. 7A, 7B and 7C are a cross-sectional view, an exploded cross-sectional view and an exploded perspective view, respectively, of a secondary battery according to one exemplary embodiment of the present invention;

FIG. 8 is a cross-sectional view of a secondary battery according to one exemplary embodiment of the present invention;

FIG. 9 is a longitudinal cross-sectional view of a portion of a secondary battery according to one exemplary embodiment of the present invention;

FIG. 10 is a flowchart illustrating a method of manufacturing a secondary battery according to one exemplary embodiment of the present invention; and

FIGS. 11A through 11F are views illustrating the manufacturing method of FIG. 10 according to one embodiment of the present invention.

### DETAILED DESCRIPTION

Exemplary embodiments will now be described more fully hereinafter with reference to the accompanying drawings; these embodiments are provided so that this disclosure will be thorough and complete, and will fully convey the scope of the invention to those skilled in the art.

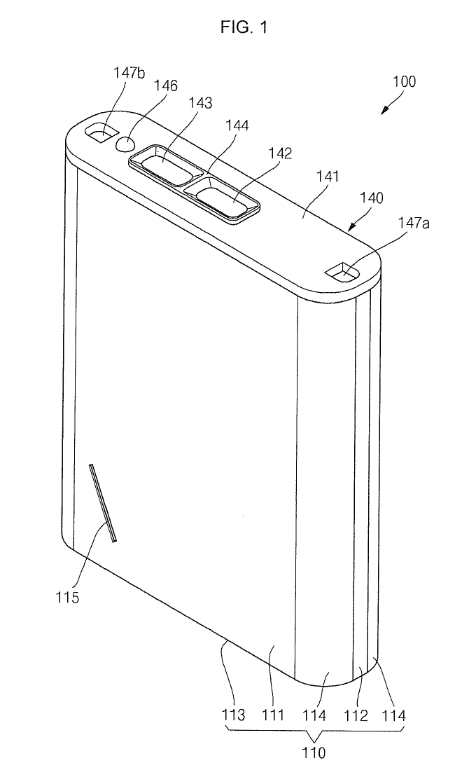

FIG. 1 is a perspective view of a secondary battery according to one embodiment of the present invention.

As illustrated in FIG. 1, the secondary battery 100 includes a substantially prismatic case 110, and a cap assembly 140 sealing an upper end of the case 110. The cap assembly 140 includes a cap plate 141, first and second electrode terminals 142 and 143, a resin molding (or injection resin molding) 144, and a sealing member 146 sealing an electrolyte injection hole.

In addition, grooves 147a and 147b having a depth (e.g., a predetermined depth) may be formed in the cap plate 141 to facilitate engagement with external devices. Further, a safety vent 115 having a relatively small thickness may be formed on either side of the case 110 to rapidly exhaust internal gases such that it fractures when an internal pressure of the case 110 increases.

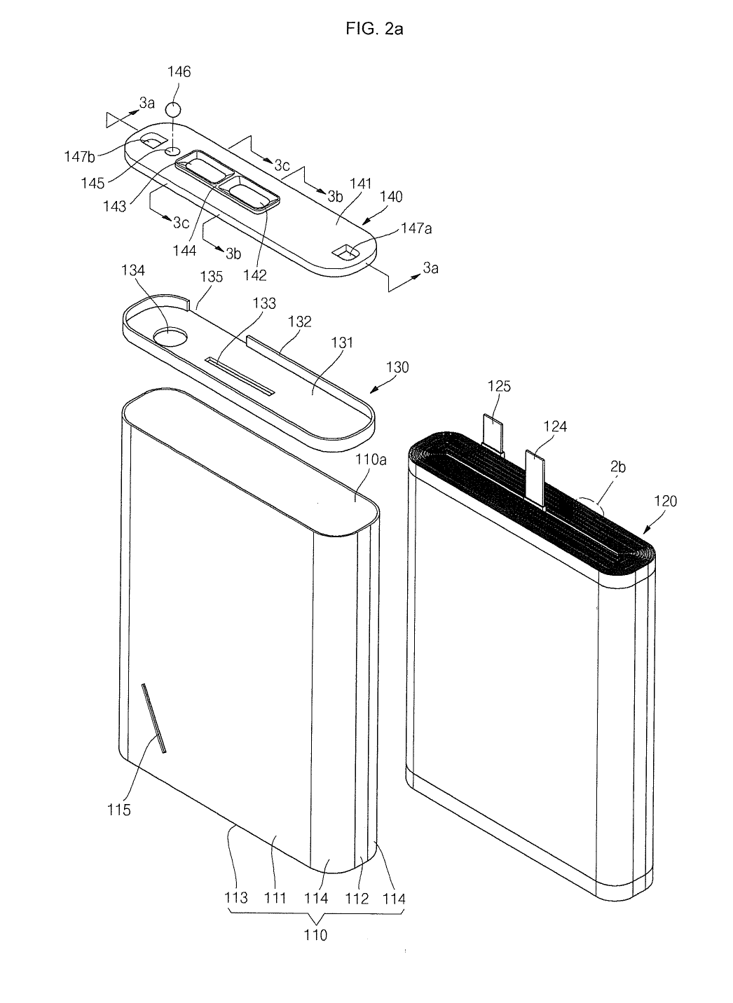

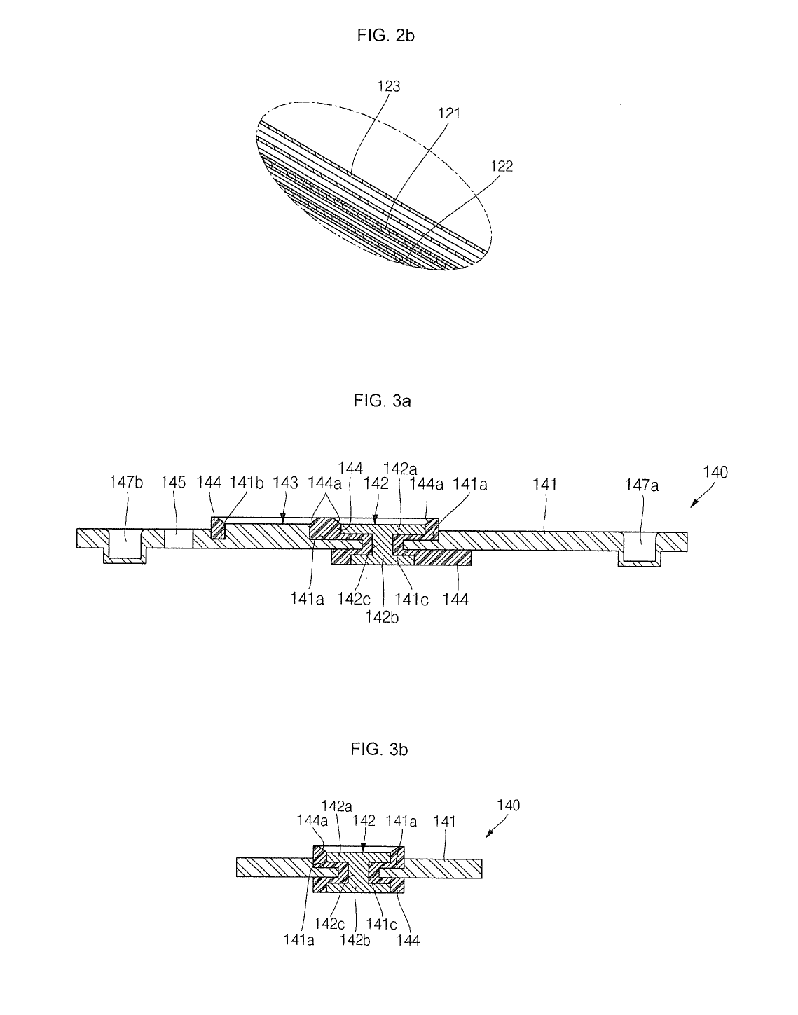

FIG. 2A is an exploded perspective view of the secondary battery illustrated in FIG. 1, and FIG. 2B is an enlarged view of a portion ‘2b’ of FIG. 2A.

As illustrated in FIGS. 2A and 2B, the secondary battery 100 includes a substantially prismatic case 110, an electrode assembly 120 having a substantially jelly-roll configuration and accommodated in the case 110, an insulation plate 130 positioned on the electrode assembly 120, and a cap assembly 140 sealing an upper end of the prismatic case 110.

The case 110 has an opening 110a formed at its top surface so as to allow the electrode assembly 120 to be inserted into the case 110 therethrough. In addition, the case 110 includes two long-side areas 111, two short-side areas 112, and a bottom area 113. The two long-side areas 111 have relatively large areas and are spaced a distance (e.g., a predetermined distance) apart from and opposing each other. The two short-side areas 112 connect opposite perimeters (or edges) of the long-side areas 111 to each other and have relatively small areas. The bottom area 113 is formed to close edges of each of the long-side areas 111 and the short-side areas 112. The bottom area 113 is formed in the opposite direction of (or on a side of the case opposing) the opening 110a. In such a manner, the case 110 has a generally rectangular prismatic shape. Further, curved areas 114 having a curvature (e.g., a predetermined curvature) may be formed between the long-side areas 111 and the two short-side areas 112. In a case where the case 110 has the curved areas 114 formed thereat, the external shape of the case 110 is substantially the same as that of the electrode assembly 120, so that there is little gap between the case 110 and the electrode assembly 120 thereby making the secondary battery 100 compact. The safety vent 115 that is relatively thin may be formed on the long-side area 111 of the case 110 to allow internal gases to be discharged to the outside the case 110 such that it fractures when an internal pressure of the case 110 increases.

Referring to FIG. 2B, the electrode assembly 120 includes a first electrode plate 121, a separator 123 and a second electrode plate 122 stacked and wound repeatedly in substantially a jelly-roll configuration. In addition, each of a first electrode tab 124 coupled to the first electrode plate 121 and a second electrode tab 125 coupled to the second electrode plate 122 extends upwardly by a length (e.g., a predetermined length). A height of the separator 123 is slightly greater than that of the first electrode plate 121 or the second electrode plate 122, so that the first electrode plate 121 and the second electrode plate 122 may not directly contact the case 110. Alternatively, an insulation tape may further be provided to wrap around the outer circumference of the electrode assembly 120.

The insulation plate 130 includes a plate area 131 that is substantially planar and a peripheral area 132 that extends upwardly by a length (e.g., a predetermined length) along the perimeter of the plate area 131. The plate area 131 has a first hole 133 formed to facilitate upward passage of the first electrode tab 124 through the insulation plate 130 and at least one second hole 134 spaced apart from the first hole 133 to facilitate injection of an electrolyte. In addition, the peripheral area 132 may have a cut-out area 135 to facilitate upward passage of the second electrode tab 125.

The cap assembly 140 includes a cap plate 141 formed in substantially a plate shape, a first electrode terminal 142 formed at approximately the center of the cap plate 141, a second electrode terminal 143 spaced apart from the first electrode terminal 142, a resin molding 144 sealing peripheral portions of the first electrode terminal 142 and the second electrode terminal 143, and a sealing member 146 for sealing an electrolyte injection hole 145 of the cap plate 141. In addition, grooves 147a and 147b each having a depth (e.g., a predetermined depth) may be formed in the cap plate 141. The cap assembly 140 having the aforementioned configuration will further be described below.

The case 110 and the cap plate 141 may be formed of aluminum, aluminum alloy, copper, copper alloy, steel, steel alloy, or stainless steel, but materials of the case 110 and the cap plate 141 are not limited to those listed herein.

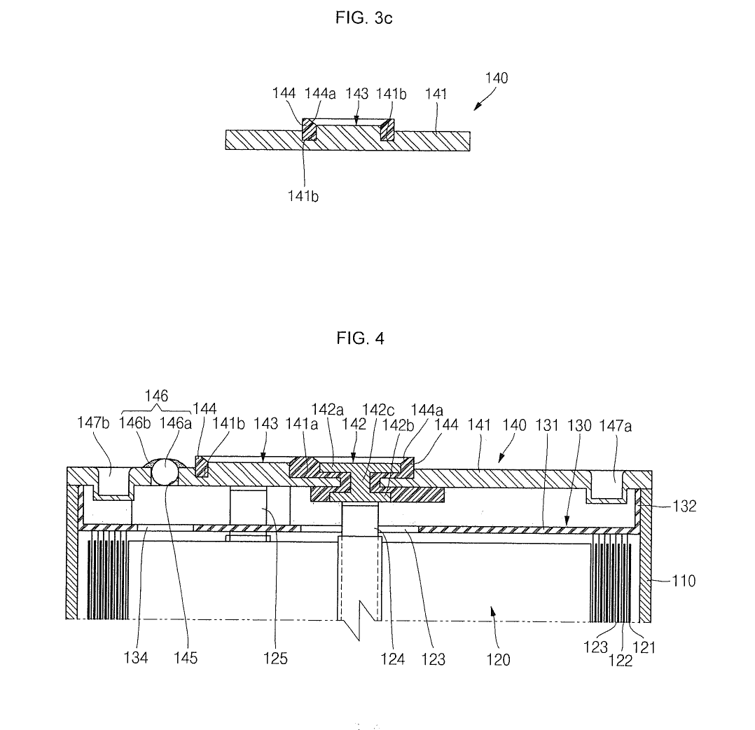

FIGS. 3A, 3B and 3C are cross-sectional views taken along lines 3a-3a, 3b-3b and 3c-3c, respectively, of FIG. 2A.

As illustrated in FIGS. 3A and 3B, the cap plate 141 includes grooves 141a and 141b each having a depth and width (e.g., a predetermined depth and width) and formed at approximately the center and the exterior (or outward portion), respectively, thereof. In addition a first hole 141c penetrating through the cap plate 141 is provided in the centrally formed groove 141a. A width of the centrally formed groove 141a is greater than a width of the outwardly formed groove 141b, and the centrally formed groove 141a and the outwardly formed groove 141b are practically coupled to each other. The first electrode terminal 142 is coupled to the centrally formed groove 141a and the first hole 141c. The first electrode terminal 142 includes an upper terminal part 142a, a lower terminal part 142b, and a connection part 142c connecting the upper terminal part 142a and the lower terminal part 142b. The upper terminal part 142a and the lower terminal part 142b may be substantially parallel plates and the connection part 142c may be between and extend in a direction substantially normal the substantially parallel plates.

A width of the upper terminal part 142a is larger than that of the lower terminal part 142b, facilitating the upper terminal part 142a to be electrically coupled to an external device. In addition, in order to allow the lower terminal part 142b to easily pass through the first hole 141c, a width of the lower terminal part 142b is equal to or slightly greater than a diameter of the first hole 141c.

Further, the upper terminal part 142a is spaced apart from the groove 141a to be positioned thereon, the lower terminal part 142b is spaced apart from the first hole 141c to be positioned thereunder, and the connection part 142c is positioned inside the first hole 141c. However, the connection part 142c is not in contact with inner walls of the first hole 141c. In addition, the first electrode terminal 142 is electrically insulated from the cap plate 141. That is, a resin molding 144 is formed in the groove 141a and the first hole 141c formed in the cap plate 141 by an insertion-molding process. In other words, the groove 141a and the first hole 141c formed in the cap plate 141 are filled with the resin molding 144 using an insertion-molding process. The resin molding 144 seals the upper terminal part 142a, the lower terminal part 142b and side regions of the connection part 142c, which are formed in the first electrode terminal 142.

The first electrode terminal 142 may be made of a material having high strength and excellent electrical conductivity, and the material may be selected from the group consisting of nickel-plated aluminum, nickel-plated copper, nickel-plated iron, nickel-plated carbon steel wires for cold heading and cold forging (sometimes referred to as JIS SWCH), equivalents thereof, and/or combinations thereof. However, the first electrode terminal 142 of embodiments of the present invention is not limited to materials listed herein.

As illustrated in FIGS. 3A and 3C, according to one embodiment of the present invention, the second electrode terminal 143 is formed on a top surface of the cap plate 141 spaced apart from the first electrode terminal 142. The groove 141b having a depth (e.g., a predetermined depth) is formed at outer sides of the second electrode terminal 143 and is filled with a resin molding 144. The second electrode terminal 143 upwardly protrudes from the groove 141b by a length (e.g., a predetermined length). In one embodiment of the present invention, the second electrode terminal 143 is a region formed by processing an area (e.g., a predetermined area) of the cap plate 141. In one embodiment, the second electrode terminal 143 is made of the same material as the cap plate 141. The side regions of the second electrode terminal 143 are also sealed (e.g., completely sealed) by the resin molding 144. In addition, heights of the first electrode terminal 142 and the second electrode terminal 143 are equal to each other for establishing a better connection with external devices. Further, the first electrode terminal 142 and the second electrode terminal 143 upwardly exposed through the resin molding 144 may be formed such that they have the same planar shape with each other.

In one embodiment, the resin molding 144 seals peripheral portions of the side regions of the first electrode terminal 142 and the second electrode terminal 143. In particular, the resin molding 144 upwardly protrudes (or has a protrusion) from the cap plate 141 by a length (e.g., a predetermined length). That is, the resin molding 144 upwardly protrudes relatively higher than the first electrode terminal 142 and the second electrode terminal 143. In such a manner, the first electrode terminal 142 and the second electrode terminal 143 may not be easily shorted by an external conductor. In addition, the resin molding 144 may further include an upwardly inclined surface 144a formed at upper portions of the first electrode terminal 142 and the second electrode terminal 143. The inclined surface 144a allows terminals of an external device to be guided into the respective centers of the first electrode terminal 142 and the second electrode terminal 143.

In one embodiment, the resin molding 144 is formed of a plastic material that can be used with injection molding. For example, the resin molding 144 may include polyvinyl chloride (PVC), polystyrene (PS), high density polyethylene (HDPE), polypropylene (PP), acrylonitrile butadiene styrene (ABS), polyacetal (POM), polyphenylene oxide (PPO), polyphenyl ether (PPE), polyamide (nylon) (PAM), polycarbonate (PC), polybutylene terephthalate (PBT), Upolymer (U), polysulfone (PSF), polyphenylene sulfide (PPS), polyetherimide (PEI), polyethersulfone (PES), polyarylate (PAR), polyether ether ketone (PEEK), polytetrafluoroethylene (PTFE), polyamide-imide (PAI), polyimide (PI), and/or equivalents thereof. In addition, the resin molding 144 may also be made of conventional fluoride resin and/or epoxy resin. However, the resin molding 144 of embodiments of the present invention are not limited to the materials listed herein.

FIG. 4 is a longitudinal cross-sectional view of a portion of FIG. 1.

As illustrated in FIG. 4, in one embodiment of the present invention, the first electrode tab 124 of the electrode assembly 120 is electrically coupled to a lower terminal part 142b of the first electrode terminal 142. Therefore, the first electrode terminal 142 will have a voltage of the first electrode (for example, a negative electrode). In addition, the second electrode tab 125 of the electrode assembly 120 is electrically coupled to the cap plate 141. Here, since the second electrode terminal 143 protrudes from the cap plate 141, the second electrode tab 125 is practically electrically coupled to the second electrode terminal 143. Therefore, the cap plate 141 and the second electrode terminal 143 will have a voltage of the second electrode (for example, a positive electrode). Since the cap plate 141 is electrically coupled to the case 110, the case 110 will also have a voltage of the second electrode.

In one embodiment of the present invention, the insulation plate 130 is interposed between the electrode assembly 120 and the cap plate 141 and prevents or protects the electrode assembly 120 from moving up and down (e.g., shifting within the case). Particularly, the peripheral area 132 of the insulation plate 130 separates (or spaces) the electrode assembly 120 and the cap plate 141 from each other by an interval or distance (e.g., a predetermined interval or distance), thereby preventing or protecting the electrode assembly 120 from moving up and down.

The electrolyte injection hole 145 formed in the cap plate 141 is sealed by the sealing member 146. The sealing member 146 includes a metal ball 146a directly contacting and closing the electrolyte injection hole 145 and a UV hardener 146b covering the metal ball 146a and a peripheral area of the metal ball 146a. Once the metal ball 146a is coupled to the electrolyte injection hole 145, it is subjected to laser welding. Next, the metal ball 146a and the laser-welded area are coated with the UV hardener 146b.

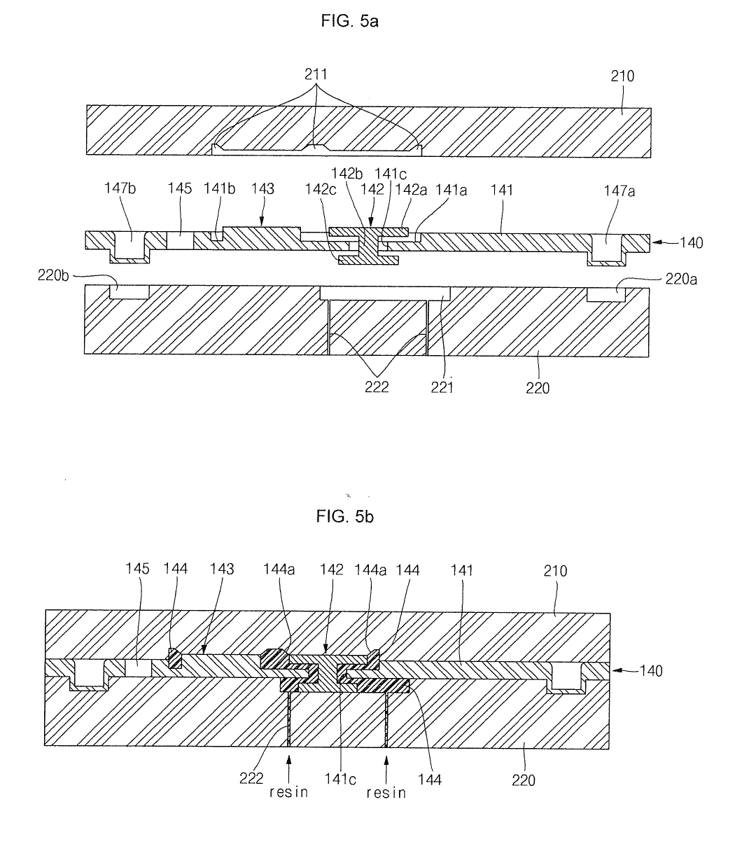

FIGS. 5A and 5B are cross-sectional views illustrating a method of manufacturing a cap assembly according to one exemplary embodiment of the present invention.

As illustrated in FIG. 5A, the cap assembly includes an upper mold 210 and a lower mold 220. The upper mold 210 includes a cavity 211 having a space (e.g., a predetermined space) to allow the resin molding 144 to be formed around the first electrode terminal 142 and the second electrode terminal 143. A portion of the upper mold 210 other than the cavity 211 is planarly formed to closely contact the top surface of the cap plate 141.

The lower mold 220 also has a cavity 221 having a space (e.g., a predetermined space) to allow the resin molding 144 to be formed around the first electrode terminal 142. A portion of the lower mold 220 other than the cavity 221 is planarly formed to closely contact the bottom surface of the cap plate 141. In addition, the lower mold 220 may include grooves 220a and 220b to allow the grooves 147a and 147b formed in the cap plate 141 to be settled (or to be engaged) thereon.

A plurality of resin injection paths 222 communicating with the cavity 221 may also be formed in the lower mold 220. Although the resin injection paths 222 are formed in the lower mold 220 in the illustrated embodiment, the resin injection paths 222 may also be formed in the upper mold 210.

As illustrated in FIG. 5B, the resin molding 144 is melted and then transferred to the cavity 221 of the lower mold 220 and the cavity 211 of the upper mold 210 through the resin injection paths 222 provided in the lower mold 220. The cavity 221 of the lower mold 220 and the cavity 211 of the upper mold 210 are coupled to each other by the first hole 141c formed in the cap plate 141. As such, the resin molding 144 is injected to the cavity 221 of the lower mold 220 and the cavity 211 of the upper mold 210, and side regions of upper portions on the first electrode terminal 142 and the second electrode terminal 143 are sealed (e.g., completely sealed) by the resin molding 144. Side regions of lower portions of the first electrode terminal 142 are also sealed (e.g., completely sealed) by the resin molding 144. In addition, the first hole 141c of the cap plate 141 coupled to the first electrode terminal 142 is also filled (e.g., completely filled) with the resin molding 144, so that the first electrode terminal 142 and the cap plate 141 may be electrically insulated (e.g., completely electrically insulated) from each other.

As described above, according to the present embodiment, a single electrode terminal, that is, the first electrode terminal 142, is coupled to the first hole 141c of the cap plate 141 and is then positioned between the upper mold 210 and the lower mold 220, and then sealed by insertion-molding the resin molding 144, thereby providing a cap assembly 140 having a reduced number of components and a simplified assembly process. In addition, since the resin molding 144 is formed to be higher than the first and second electrode terminals 142 and 143, the first and second electrode terminals 142 and 143 are not electrically shorted from each other by an external conductor. In addition, the resin molding 144 may further include an upwardly inclined surface 144a formed at upper portions of the first electrode terminal 142 and the second electrode terminal 143, thereby allowing terminals of an external device to be guided into the respective centers of the first electrode terminal 142 and the second electrode terminal 143.

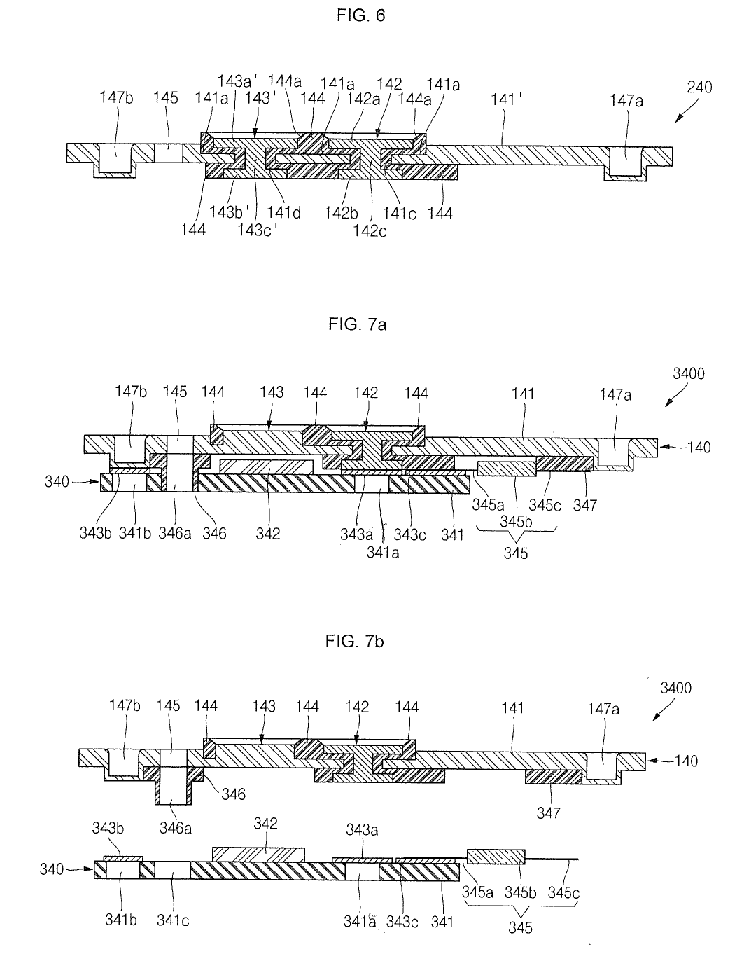

FIG. 6 is a cross-sectional view of a cap assembly according to one exemplary embodiment of the present invention.

As illustrated in FIG. 6, in the cap assembly 240, not only the first electrode terminal 142 but also the second electrode terminal 143′ may be electrically insulated from the cap plate 141′.

In more detail, the second electrode terminal 143′ includes an upper terminal part 143a′ upwardly protruding from the cap plate 141′, a lower terminal part 143b′ downwardly protruding from the cap plate 141′, and a connection part 143c′ electrically connecting the upper terminal part 143a′ and the lower terminal part 143b′. In order to allow the second electrode terminal 143′ to be coupled to the cap plate 141′, the cap plate 141′ may include a second hole 141d. In addition, in order to make the upper terminal part 142a of the first electrode terminal 142 and the upper terminal part 143a′ of the second electrode terminal 143′ sufficiently spaced apart from each other, a width of a groove 141a′ may be greater than the sum of widths of the first electrode terminal 142 and the second electrode terminal 143 (and/or a distance between holes 141c and 141d may be greater than half the sum of the widths of the first and second electrode terminals 142 and 143).

In such a manner, the resin molding 144 is formed around the upper terminal part 143a′ of the second electrode terminal 143′, the lower terminal part 143b′ and the connection part 143c′. That is, the resin molding 144 seals peripheral portions of the upper or lower terminal part 143a′ or 143b′ of the second electrode terminal 143′. In addition, the resin molding 144 fills the second hole 141d to seal the connection part 143c′ of the second electrode terminal 143′.

Accordingly, the first electrode terminal 142 and the second electrode terminal 143′ are endowed with polarities (or have electrical voltages), but the cap plate 141′ or the case 110 is not endowed with polarity (e.g., is electrically floating). That is, a first electrode tab 124 is coupled to the lower terminal part 142b of the first electrode terminal 142, and a second electrode tab 125 is coupled to the lower terminal part 143b′ of the second electrode terminal 143′.

As described above, according to the present embodiment, the first electrode terminal 142 and the second electrode terminal 143′ are coupled to the cap plate 141′, and sealed by insertion-molding the resin molding 144, thereby providing the cap assembly 140 with a reduced number of components and a simplified assembly process.

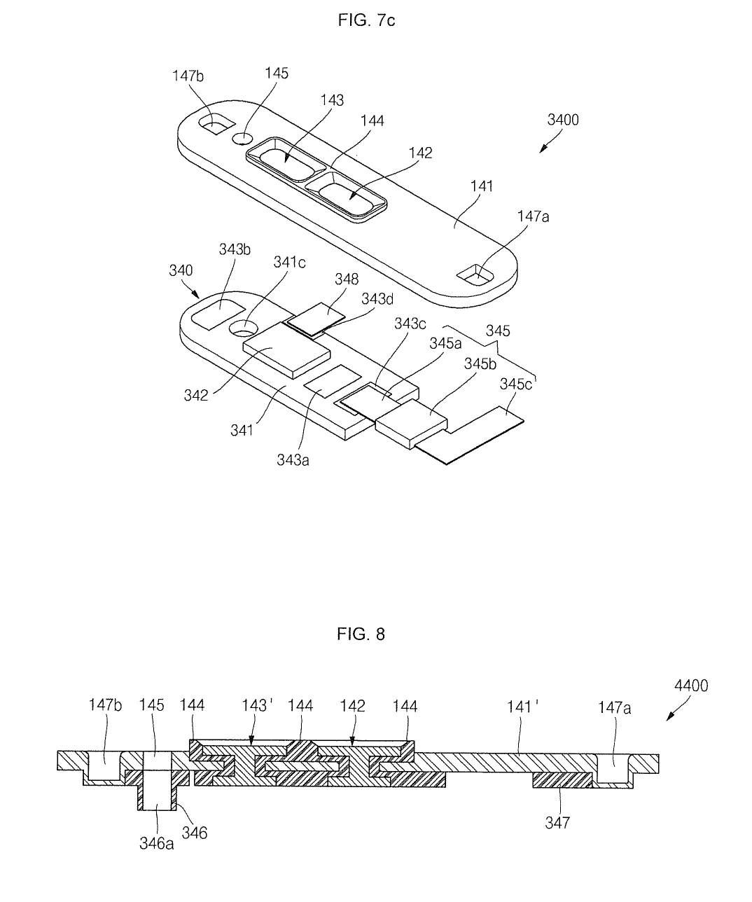

FIGS. 7A, 7B and 7C are a cross-sectional view, an exploded cross-sectional view and an exploded perspective view, respectively, of a secondary battery according to one exemplary embodiment of the present invention.

As illustrated in FIGS. 7A, 7B and 7C, the cap assembly 3400 includes a protective circuit module 340.

The protective circuit module 340 includes a board (or a circuit board) 341 having a plurality of holes 341a, 341b, and 341c; a circuit device 342 mounted on the board 341 and for preventing (or protecting from) overcharge, overdischarge and/or overcurrent of a battery cell; a first conductive pad 343a and a second conductive pad 343b electrically coupled to the first electrode terminal 142 and the second electrode terminal 143′ of the cap assembly 140, respectively; a fuse element 345 mounted on the board 341 and electrically coupled to the first electrode tab 124; and a conductive lead 348 communicating with the board 341 and electrically coupled to the second electrode tab 125.

The board 341 includes a third conductive pad 343c communicating with the fuse element 345, and a fourth conductive pad 343d communicating with the conductive lead 348. The fuse element 345 includes a first lead 345a, a fuse body 345b, and a second lead 345c. The first lead 345a is coupled to the third conductive pad 343c of the board 341, and the second lead 345c is electrically coupled to the first electrode tab 124.

A first auxiliary resin molding 346 and a second auxiliary resin molding 347 may further be formed between the protective circuit module 340 and the cap assembly 140. In more detail, the first auxiliary resin molding 346 is formed at an area corresponding to the injection hole 145 of the cap plate 141. The first auxiliary resin molding 346 also includes a hole 346a to allow for passage of an electrolyte. The first auxiliary resin molding 346 penetrates through the hole 341c formed in the board 341. In such a manner, a position of the protective circuit module 340 is fixed or secured by the first auxiliary resin molding 346, and the likelihood of an electrical short between the cap plate 141 and the protective circuit module 340 can also be reduced.

In addition, the second auxiliary resin molding 347 is formed at the cap plate 141 positioned at an area corresponding to the second lead 345c of the fuse element 345. Accordingly, the likelihood of an electrical short between the cap plate 141 and the second lead 345c of the fuse element 345 can be reduced by the second auxiliary resin molding 347.

The first auxiliary resin molding 346 and the second auxiliary resin molding 347 may be formed together with the resin molding 144 that seals the first electrode terminal 142 and the second electrode terminal 143′. Alternatively, the first auxiliary resin molding 346 and the second auxiliary resin molding 347 may be formed separately from the resin molding 144 that seals the first electrode terminal 142 and the second electrode terminal 143′. In addition, the first auxiliary resin molding 346 and the second auxiliary resin molding 347 may be made of the same material as the resin molding 144.

In addition, since the circuit device 342 is positioned at a space between the resin molding 144 and the first auxiliary resin molding 346, it does not interfere with other components. In addition, since the first lead 345a of the fuse element 345 is formed at an area corresponding to the resin molding 144, the likelihood of an electrical short between the first lead 345a of the fuse element 345 and the cap plate 141 can be reduced.

The first conductive pad 343a is directly coupled to the lower terminal part 142b of the first electrode terminal 142 by resistance welding or laser welding. Here, a welding tool may approach the first conductive pad 343a through the hole 341a formed in the board 341. The second conductive pad 343b is also coupled to the cap plate 141 by resistance welding or laser welding. In one embodiment, the second conductive pad 343b may be electrically coupled to the bottom of a groove 147b provided in the cap plate 141. A welding tool may approach (or be brought into contact with) the second conductive pad 343b through the hole 341a formed in the board 341.

Here, the fuse element 345 may function as a current (or circuit) breaker when the internal temperature of a battery cell rises to a reference temperature or higher. For example, the fuse element 345 may be a positive temperature coefficient (PTC) device, a bimetal circuit breaker, or an equivalent thereof, but embodiments of the present invention are not limited to the kinds of fuse elements listed herein.

FIG. 8 is a cross-sectional view of a secondary battery according to one exemplary embodiment of the present invention.

As illustrated in FIG. 8, like in the previous embodiment, in the cap assembly 4400, a first electrode terminal 142 and a second electrode terminal 143′ may be formed separately from the cap plate 141′. In addition, a first auxiliary resin molding 346 and a second auxiliary resin molding 347 are formed at one side portion of the first electrode terminal 142 and one side portion of the second electrode terminal 143′, respectively. A first conductive pad 343a of a protective circuit module 340 is directly electrically coupled to the first electrode terminal 142, and the second conductive pad 343b is directly electrically coupled to the second electrode terminal 143′.

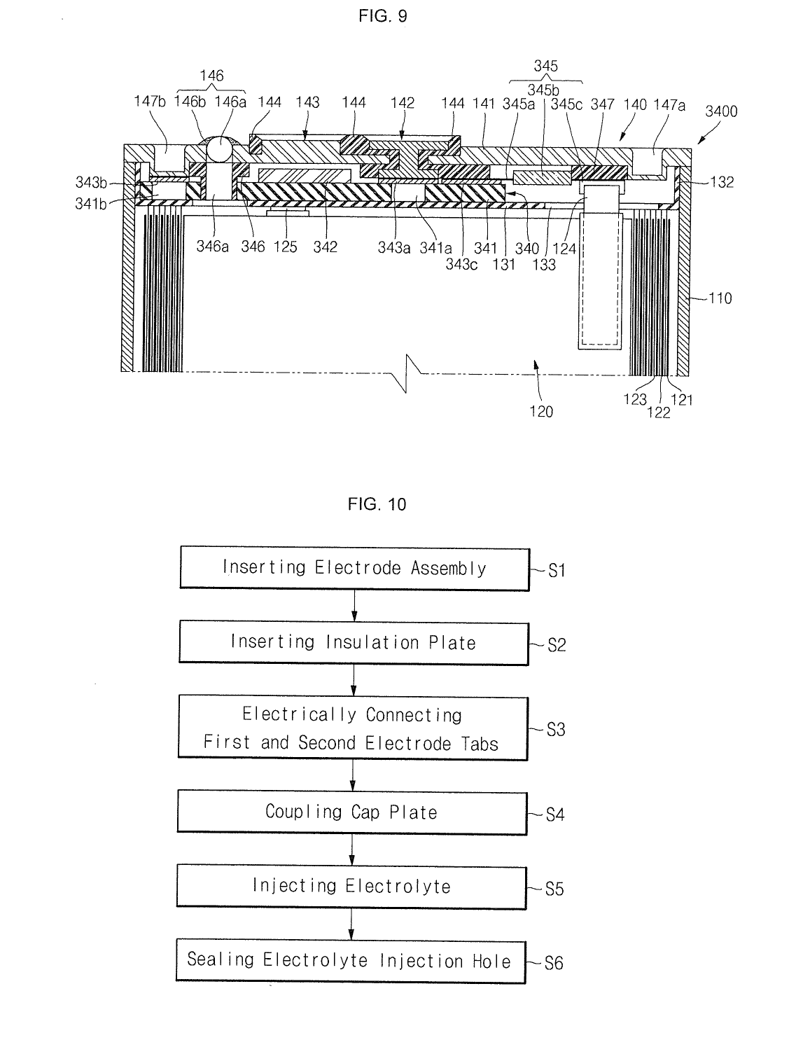

FIG. 9 is a longitudinal cross-sectional view of a portion of a secondary battery according to one exemplary embodiment of the present invention.

As illustrated in FIG. 9, a first electrode tab 124 extending from an electrode assembly 120 is electrically coupled to a second lead 345c of a fuse element 345. Accordingly, the first electrode tab 124 is electrically coupled to a first electrode terminal 142 through the second lead 345c of the fuse element 345, a fuse body 345b, a first lead 345a, a third conductive pad 343c, and a first conductive pad 343a. A conductive pattern is formed in a board 341, so that the first conductive pad 343a and the third conductive pad 343c are electrically coupled to each other.

The second electrode tab 125 is electrically coupled to a conductive lead (348 of FIG. 7C) provided in the protective circuit module 340. Accordingly, the second electrode tab 125 is electrically coupled to a cap plate 141 through the conductive lead 348, a fourth conductive pad (343d of FIG. 7C) and a second conductive pad 343b. A conductive pattern is formed in the board 341 so that the second conductive pad 343b and the fourth conductive pad 343d are electrically coupled to each other. Since the second electrode terminal 143′ is integrally formed with the cap plate 141, the second electrode tab 125 is electrically coupled to the second electrode terminal 143.

The protective circuit module 340 is configured such that it is inserted between the cap assembly 140 and the insulation plate 130. Accordingly, it is possible to prevent (or protect) the protective circuit module 340 from moving between the cap assembly 140 and the insulation plate 130.

In such a manner, according to the present embodiment, the protective circuit module 340 is housed inside the secondary battery. Therefore, the external shape of the secondary battery is further simplified. In other words, since a process of separately attaching a protective circuit module to the exterior of the secondary battery is skipped, the assembly process of the secondary battery is simplified and the external shape of the secondary battery is further simplified. In other words, according to embodiments of the present invention, since the cap assembly 3400 or 4400 with the prefabricated protective circuit module 340 attached thereto is provided, the protective circuit module 340 can be housed inside the secondary battery by electrically connecting the cap assembly 3400 or 4400 to the electrode assembly 110 and sealing the case 110 with the cap assembly 3400 or 4400.

FIG. 10 is a flowchart illustrating a method of manufacturing a secondary battery according to one exemplary embodiment of the present invention.

As illustrated in FIG. 10, the method of manufacturing the secondary battery 100 includes inserting an electrode assembly (S1), inserting an insulation plate (S2), electrically connecting first and second electrode tabs (S3), coupling a cap plate (S4), injecting an electrolyte (S5), and sealing an injection hole (S6).

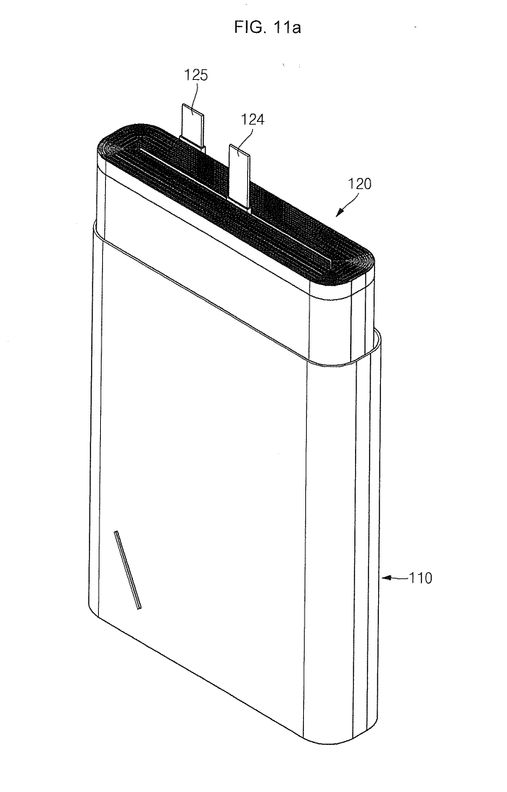

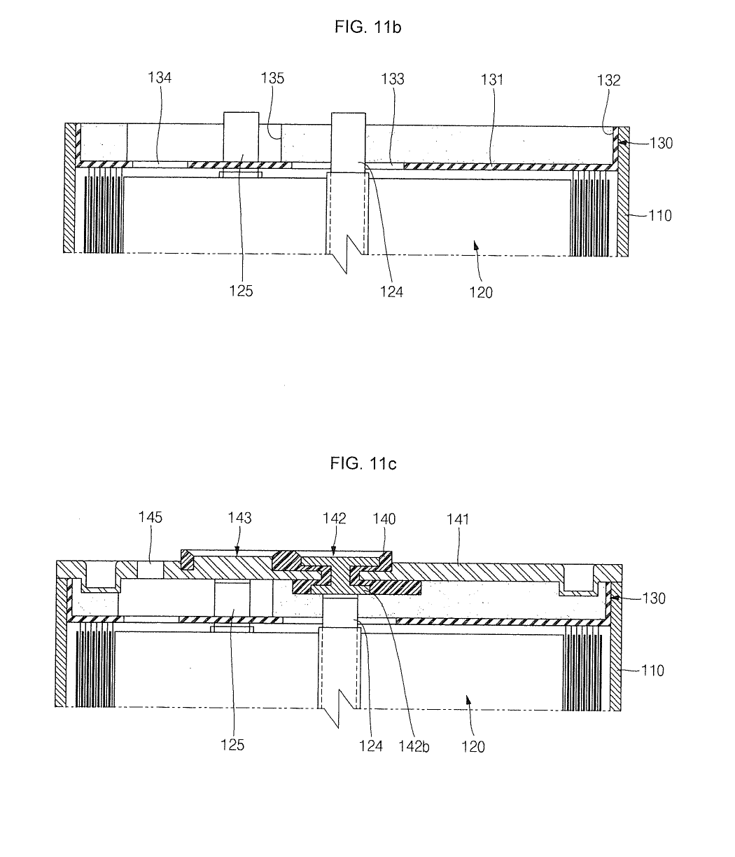

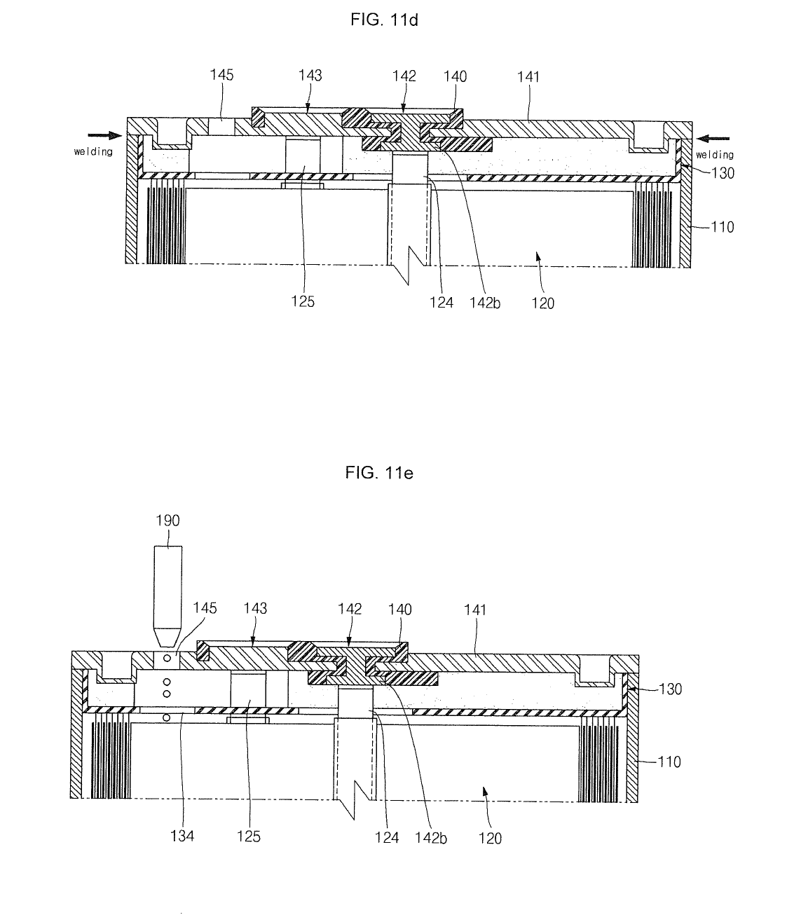

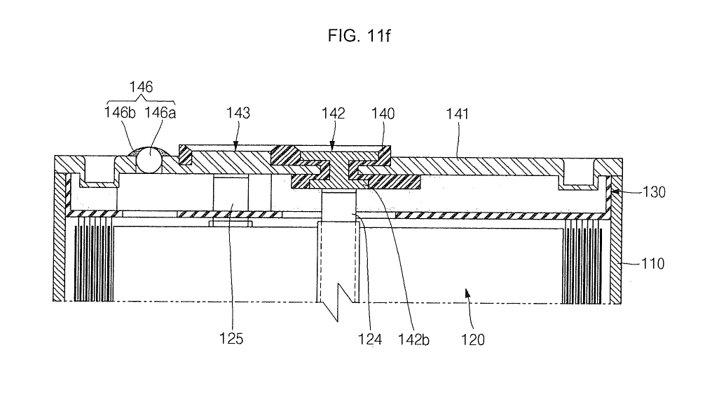

FIGS. 11A through 11F are views sequentially illustrating the manufacturing method of FIG. 10 according to one embodiment of the present invention.

The method of manufacturing the secondary battery 100 will now be described in greater detail with reference to FIGS. 11A through 11F together with FIG. 10. It is noted that the cap assembly 140 is prefabricated using the cap plate 141, the first electrode terminal 142 and the resin molding 144 by an insertion-molding process.

As illustrated in FIG. 11A, in the inserting of an electrode assembly (S1), an electrode assembly 120 including a first electrode tab 124 and a second electrode tab 125 are inserted into a case 110 having an opening formed at its upper end. Here, the first electrode tab 124 and the second electrode tab 125 upwardly extend from the electrode assembly 120 by a length (e.g., a predetermined length), respectively.

As illustrated in FIG. 11B, in the inserting of an insulation plate (S2), an insulation plate 130 is inserted into the case 110. That is, the insulation plate 130 is settled on an upper part of the electrode assembly 120. Here, the insulation plate 130 includes a plate area 131, a peripheral area 132, a first hole 133, a second hole 134, and a cut-out area 135. Therefore, the first electrode tab 124 penetrates through the first hole 133 to upwardly extend, and the second electrode tab 125 penetrates through the cut-out area 135 to upwardly extend.

As illustrated in FIG. 11C, in the electrically connecting of first and second electrode tabs (S3), the first electrode tab 124 is electrically coupled to the first electrode terminal 142 of the cap assembly 140, and the second electrode tab 125 is electrically coupled to the second electrode terminal 143 of the cap assembly 140. That is, the first electrode tab 124 is electrically coupled to a lower terminal part 142b of the first electrode terminal 142, and the second electrode tab 125 is electrically coupled to the bottom of the cap plate 141. Here, a resin molding 144 electrically insulates the first electrode terminal 142 from the cap plate 141. On the other hand, the second electrode terminal 143 is electrically coupled to the cap plate 141.

As illustrated in FIG. 11D, in the coupling of a cap plate (S4), the cap plate 141 is coupled to a case 110. That is, a peripheral region of the cap plate 141 is coupled to the case 110 by laser welding.

As illustrated in FIG. 11E, in the injecting of an electrolyte (S5), the electrolyte is injected into the cap plate 141 through an electrolyte injection hole 145 using an electrolyte injection tool 190. The thus-injected electrolyte is transferred to the electrode assembly 120 through a second hole 134 formed in an insulation plate 130.

As illustrated in FIG. 11F, in the sealing of an electrolyte injection hole (S6), a metal ball 146a is engaged with the electrolyte injection hole 145 provided in the cap plate 141, and a peripheral region of the metal ball 146a is subjected to laser welding. Next, an ultraviolet (UV) hardener 146b is coated on surfaces of the metal ball 146a and the laser-welded area. When UV rays are irradiated onto the surface of the UV hardener 146b, the UV hardener 146b is hardened to, e.g., complete the sealing of the electrolyte injection hole 145.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

DESCRIPTION OF THE SYMBOLS IN MAIN PORTIONS
OF THE DRAWINGS

| | |
|---|---|
| 100; Secondary Battery | |
| 110; Case | 120; Electrode Assembly |
| 130; Insulation Plate | 140; Cap Assembly |
| 141; Cap Plate | 141a, 141b; Groove |
| 141c; First Hole | 142; First Electrode Terminal |
| 142a; Upper Terminal Part | 142b; Lower Terminal Part |
| 142c; Connection Part | 143; Second Electrode Terminal |
| 144; Resin Molding | 145; Injection Hole |
| 146; Sealing Member | 146a; Metal Ball |
| 146b; Hardener | |

What is claimed is:

1. A cap assembly comprising:
a cap plate having a first hole;
a first electrode terminal inserted into and extending out from the first hole of the cap plate, the first electrode terminal comprising an upper terminal part, a lower terminal part, and a connection part electrically connecting the upper terminal part with the lower terminal part; and
an injection resin molding between the first hole and the first electrode terminal to seal the first hole around the first electrode terminal.

2. The cap assembly of claim 1, wherein the upper terminal part has a cross-sectional latitudinal dimension larger than that of the lower terminal part to facilitate electrical connection of the upper terminal part with an external device.

3. The cap assembly of claim 1, wherein the cap plate has a groove at an upper surface of the cap plate to receive the upper terminal part, the groove being filled with the injection resin molding.

4. The cap assembly of claim 1, wherein the injection resin molding surrounds the first electrode terminal and has a protrusion extending above an upper surface of the cap plate to be higher than the first electrode terminal.

5. The cap assembly of claim 4, wherein the protrusion of the injection resin molding has an inclined surface configured to guide a terminal of an external device onto the first electrode terminal.

6. The cap assembly of claim 1, further comprising a second electrode terminal, wherein:
the cap plate has:
a first groove at an upper surface of the cap plate to receive the upper terminal part of the first electrode terminal, and
a second groove at a periphery of the second electrode terminal, and
the injection resin molding is in the first and second grooves and surrounds the first and second electrode terminals.

7. The cap assembly of claim 6, wherein the second electrode terminal and the cap plate are composed of a same material.

8. The cap assembly of claim 6, wherein the second electrode terminal comprises a protruding portion of the cap plate.

9. The cap assembly of claim 6, wherein the second electrode terminal comprises an upper terminal part, a lower terminal part, and a connection part electrically connecting the upper terminal part and the lower terminal part.

10. The cap assembly of claim 9, wherein the injection resin molding electrically insulates the first and second electrode terminals from the cap plate.

11. A rechargeable battery comprising:
a case;
an electrode assembly in the case;
a protective circuit module electrically coupled to the electrode assembly, and in the case; and
a cap assembly electrically coupled to the protective circuit module, and sealing the electrode assembly and the protective circuit module in the case.

12. The rechargeable battery of claim 11, wherein the cap assembly comprises:
a cap plate having a hole;
an electrode terminal inserted into and extending out from the hole of the cap plate, the electrode terminal comprising an upper terminal part, a lower terminal part, and a connection part electrically connecting the upper terminal part with the lower terminal part; and
an injection resin molding between the hole and the electrode terminal to seal the hole around the electrode terminal.

13. The rechargeable battery of claim 12, wherein the protective circuit module comprises:
a board;
a first conductive pad on the board and electrically connected to the electrode terminal; and
a second conductive pad on the board and electrically connected to the cap plate.

14. The rechargeable battery of claim 13, wherein the board has:
a first hole corresponding to the first conductive pad to allow a welding tool to approach the first conductive pad, and
a second hole corresponding to the second conductive pad to allow a welding tool to approach the second conductive pad.

15. The rechargeable battery of claim 13, wherein the protective circuit module further comprises:
a third conductive pad on the board and electrically connected to a first electrode tab of the electrode assembly; and
a fourth conductive pad on the board and electrically connected to a second electrode tab of the electrode assembly.

16. The rechargeable battery of claim 15,
wherein a fuse element is electrically coupled between the third conductive pad and the first electrode tab of the electrode assembly, and
wherein a conductive lead is electrically coupled between the fourth conductive pad and the second electrode tab of the electrode assembly.

17. The rechargeable battery of claim 11, further comprising:
a first auxiliary resin molding and a second auxiliary resin molding, the first and second auxiliary resin moldings being between the protective circuit module and the cap assembly.

18. The rechargeable battery of claim 17,
wherein the cap assembly has an injection hole,
wherein the first auxiliary resin molding has a first hole, and
wherein the injection hole corresponds to the first hole.

19. The rechargeable battery of claim 17,
wherein the protective circuit module has a first hole, and
wherein the first auxiliary resin molding penetrates through the first hole.

20. The rechargeable battery of claim 11,
wherein an insulation plate is between the electrode assembly and the protective circuit module.
